(19) United States
(12) Patent Application Publication
(10) Pub. No.: US 2016/0014998 A1
(43) Pub. Date: Jan. 21, 2016

(54) ANIMAL FEEDER

(71) Applicant: James Baker, West Plains, MT (US)

(72) Inventor: James Baker, West Plains, MT (US)

(21) Appl. No.: 14/867,006

(22) Filed: Sep. 28, 2015

(51) Int. Cl. A01K 5/01; A01K 5/02; A01K 5/00

(52) U.S. Cl. CPC A01K 5/0107; A01K 5/008; A01K 5/02

(57) ABSTRACT

A portable animal feeder comprising a horizontal top frame attached with a plurality of adjustable legs extending downwards, wherein the top frame and adjustable legs are made of light weight material such as aluminum or steel. The animal feeder further comprises a tapered compartment made of weather proof fabric, the tapered compartment or feed bag is removably attached to the horizontal top frame, for holding a predefined quantity of animal feed and an adapter ring at a bottom of the tapered fabric compartment, for attaching a self-feeder or an automatic feed thrower.

### FIELD OF THE INVENTION

The present disclosure generally relates to the technical field of animal feeder and more specifically relates to a portable deer feeder comprising water resistant fabric feed bag placed within a body frame with adjustable legs constructed using light weight material for easy assembly, disassembly and portability of the feeder.

### BACKGROUND

Animal feeders have become increasingly popular and are used for a variety of purposes. For example, some feeders are used to feed large domestic livestock such as horses and cattle and smaller animals such as dogs and cats. Others types of animal feeders are used to attract wildlife such as deer or other animals for viewing, photographing, or hunting purposes. Deer feeders are configured to deliver feed comprising corn and grain as well as specialized pellets providing important nutrients. These feeders were placed in areas known to have open access by deer.

Size, shape and design of the feeder may vary with the intended application. One type of feeder may comprise a container or drum supported by legs or suspended from a tree or beam, and a controller that regulates feed distribution. The controllers are equipped with automatic timers which allow the user to distribute feed at predetermined intervals for specified periods of time. Most feeders also have a distribution mechanism, or spinner, that throws the feed around the surrounding radius.

Conventional tri-stand feeders are too heavy to transfer from one place to another, which is frequently required as most of the hunters depend on government land and do not own a land for hunting. Studies have suggested that proper height of the feeder prevents other animals from feeding. Conventional feeders with rigid stand provide a fixed height for the animal to reach in order to receive feed. Automatic feeder or timed feeder results in waste of feed when there is lack of animal activity. In addition, adverse environmental conditions such as temperature, rainfall, humidity and variation in moisture levels may result in wastage of the feed placed inside a feed bag.

Therefore, there exists a need in the art for an improved and portable animal feeder comprising lightweight frame with adjustable legs and further comprising weather-proof, light weight feed compartment.

### SUMMARY OF THE INVENTION

The present disclosure relates to a portable animal feeder comprising: a horizontal top frame attached with a plurality of adjustable legs, wherein the top frame and adjustable legs are made of light weight material and a tapered compartment removably attached to the horizontal top frame, for holding a predefined quantity of animal feed. The animal feeder further comprise an adapter ring at a bottom of the tapered fabric compartment, for attaching a self-feeder or an automatic feeder.

In an embodiment, the animal feeder comprise a deer feeder. The light weight material comprises aluminum or steel which offers easy assembling or dismantling and portability. The tapered compartment or feed bag is made of a water resistant, UV resistant and temperature resistant fabric material. The horizontal top frame may comprise a circular frame fixedly attached to the plurality of telescoping legs using which the height of the animal feeder can be adjusted for preventing feeding by other animals.

In another embodiment, the tapered compartment is placed within the horizontal top frame while assembling the feeder. In an alternative embodiment, the tapered compartment can be removably attached beneath the horizontal top frame of the feeder. In an embodiment, the animal feeder assembly comprises a horizontal top frame removably attached with a plurality of height adjustable legs and a weather proof feed bag or tapered fabric compartment placed within the horizontal top frame. The animal feeder assembly can be accommodated within a back pack or a travel bag for easy portability.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF SEVERAL VIEWS OF DRAWINGS

FIG. 1 illustrates a side perspective view of the animal feeder device.

FIG. 2 illustrates a top view of the animal feeder device.

### DETAILED DESCRIPTION OF DIFFERENT EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of claims are to be embraced within their scope.

The present disclosure generally relates to a portable animal feeder. In one embodiment the animal feeder comprise a deer feeder with modular components such as top frame, adjustable legs and a feed bag made of lightweight materials. The simple design and light weight material of the feeder device facilitates easy assembly, disassembly, portability and storage.

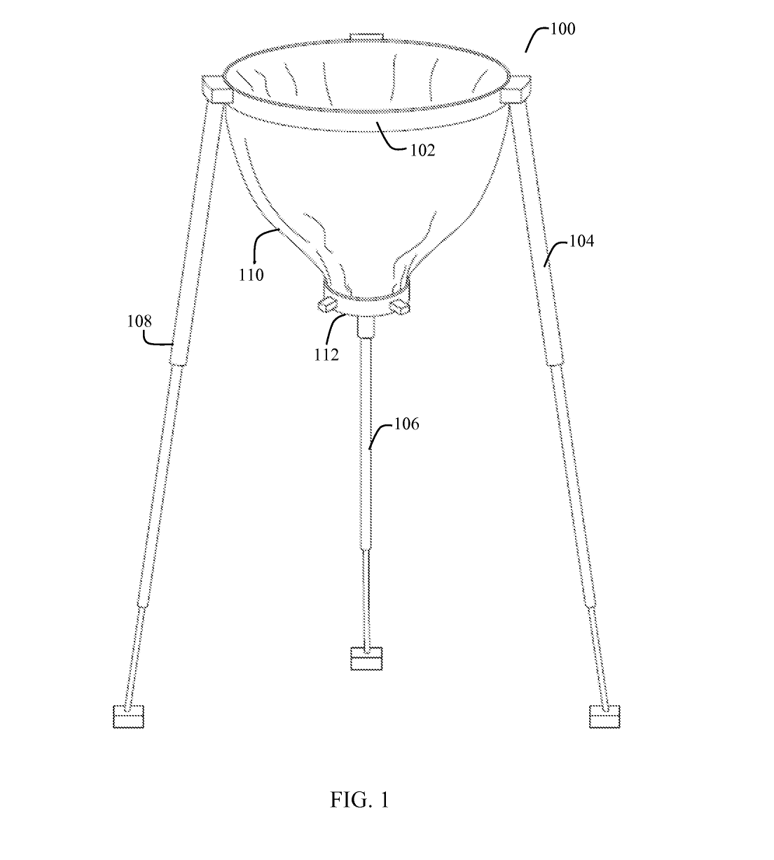

Referring to FIG. 1, which illustrates a side perspective view of the animal feeder device 100, comprising a horizontal top frame 102 attached with a plurality of adjustable legs 104, 106 and 108, extending downwards from the top frame 102. In one embodiment, the horizontal top frame 102 may comprise a circular frame made of light weight material such as aluminum or steel. The adjustable legs 104, 106, 108 are also made of light weight material, which enables easy transportation of the animal feeder device.

The animal feeder 100 of the present disclosure further comprise a tapered compartment 110 removably attached to the horizontal top frame 102, for holding a predefined quantity of animal feed. In an embodiment, a tapered compartment 110 comprise a feed bag or feed holder made of a water resistant, UV resistant and temperature resistant fabric material. The animal feeder 100 further comprise an adapter ring 112 at a bottom of the tapered compartment 110, for attaching a self-feeder device or an automatic feed thrower (not shown).

In an embodiment, the animal feeder comprise a deer feeder. The horizontal top frame 102 and legs 104, 106, 108 are made of light weight material such as aluminum or steel, which offers easy assembling or dismantling and portability. The horizontal top frame 102 may comprise a non-circular frame. The plurality of adjustable legs 104, 106 and 108 comprise telescoping legs using which the height of the animal feeder 100 can be adjusted for preventing feeding by other animals thereby allowing selective feeding by deer. In an embodiment, the height of the legs 104, 106, 108 can be adjusted from 24 inches to 96 inches.

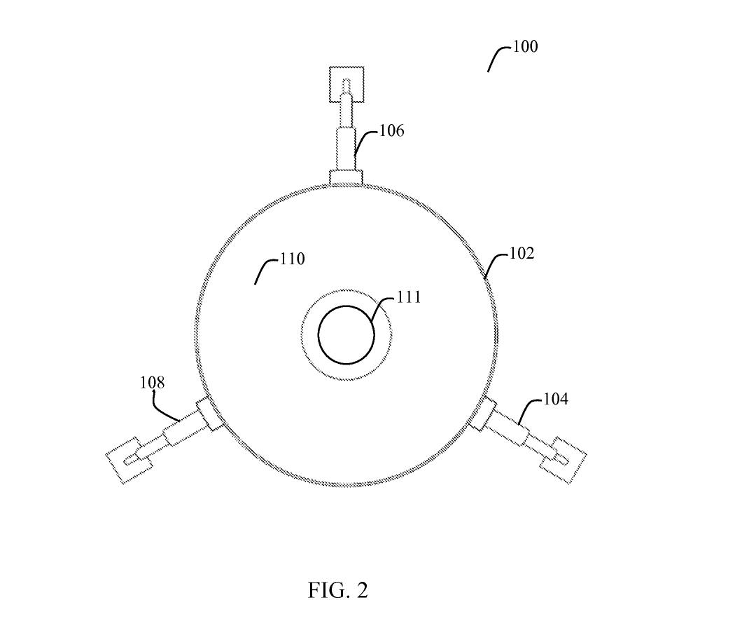

FIG. 2 illustrates a top view of the animal feeder device 100, comprising a horizontal top frame 102 resting on the plurality of telescoping legs 104, 106, 108. The feed bag or feed holder 110 placed within the top frame 102 such that the feed holder 110 taper downwards from the top frame 102. The bottom of the feed holder 110 further comprise an opening 111, fitted on the outside with an adapter 112 (not shown) for attaching an automatic feed thrower or a self-feeder.

In another embodiment, the tapered compartment 110 is placed within the horizontal top frame 102 while assembling the feeder 100. In an alternative embodiment, the tapered compartment 110 can be removably attached beneath the horizontal top frame 102 of the feeder 100. The tapered compartment 110 comprise a feed holder capable of holding 50 to 100 pounds of feed. The feed material may comprise corn or grains.

In an embodiment, the animal feeder assembly comprises a horizontal top frame removably attached with a plurality of height adjustable legs and a weather-proof feed bag (tapered fabric compartment) placed within the horizontal top frame. The animal feeder assembly can be accommodated within a back pack or a travel bag for easy portability. In one embodiment, the animal feeder assembly weighs around 40-50 pounds.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A portable animal feeder comprising:
a horizontal top frame attached with a plurality of adjustable legs, wherein the top frame and adjustable legs are made of light weight material;
a tapered compartment removably attached to the horizontal top frame, for holding a predefined quantity of animal feed; and
an adapter ring placed at a bottom of the tapered compartment, for attaching a self-feeder or an automatic feeder.

2. The portable animal feeder of claim 1, wherein the light weight material comprises aluminum or steel.

3. The portable animal feeder of claim 1, wherein the tapered compartment is made of a water resistant fabric.

4. The portable animal feeder of claim 3, wherein the fabric is resistant to Ultraviolet (UV) radiation.

5. The portable animal feeder of claim 1, wherein the plurality of adjustable legs comprise telescoping legs.

6. The portable animal feeder of claim 1, wherein the horizontal top frame comprises a circular frame.

7. The portable animal feeder of claim 1, wherein the animal feeder comprises a deer feeder.

8. The portable animal feeder of claim 1, wherein the tapered compartment comprises a feed bag.

9. The portable animal feeder of claim 1, wherein the tapered compartment is placed within the horizontal top frame.

10. The portable animal feeder of claim 1, wherein the tapered compartment is attached beneath the horizontal top frame.
